(19) United States
(12) Patent Application Publication
(10) Pub. No.: US 2026/0179610 A1
(43) Pub. Date: Jun. 25, 2026

(54) SYSTEM FOR CONVERTING VOICE TO COMMANDS

(71) Applicant: Lenovo (United States) Inc., Morrisville, NC (US)

(72) Inventors: Eduardo Camilo do Canto, São José (BR); Alexandre Reeberg de Mello, Florianópolis (BR); Carlos Antonio Campos Jorge, Brasília (BR); Durval da Silva Neto, São José (BR); Felipe Ofugi Hara, Brasília (BR); Rafael Souza Costa, Florianopolis (BR); Leonardo Persike Martins, Florianópolis (BR); Luana da Silva Machado, Florianópolis (BR)

(21) Appl. No.: 18/987,664

(22) Filed: Dec. 19, 2024

(51) Int. Cl. G10L 15/22; G10L 15/18

(52) U.S. Cl. CPC G10L 15/22; G10L 15/1822; G10L 2015/223

(57) ABSTRACT

A computer implemented method for deriving commands from voice includes receiving a voice request to execute a command for a device. A text string is obtained corresponding to the voice request. The text string is tokenized to generate text string tokens. The text string tokens are input to a text classifier trained to identify command classes corresponding to the voice request, the command classes including a search class command, a time class command, and other commands. Information is extracted from the text string tokens via a string parser for a search class command. Time information is extracted from the text string tokens via a time parser and resulting commands and extracted information are provided to the device for execution.

### BACKGROUND

Implementing voice commands for limited computing resource electronic devices utilize cloud service based large language models to process text. It is difficult to implement voice commands in embedded systems which are usually computing resource constrained and sometimes lack network access for use in accessing cloud resources.

### SUMMARY

A computer implemented method for deriving commands from voice includes receiving a voice request to execute a command for a device. A text string is obtained corresponding to the voice request. The text string is tokenized to generate text string tokens. The text string tokens are input to a text classifier trained to identify command classes corresponding to the voice request, the command classes including a search class command, a time class command, and other commands. Information is extracted from the text string tokens via a string parser for a search class command. Time information is extracted from the text string tokens via a time parser and resulting commands and extracted information are provided to the device for execution.

### BRIEF DESCRIPTION OF THE DRAWINGS

FIG. 1 is a block diagram of an improved voice to command interaction system according to an example embodiment.

FIG. 2 is a block diagram illustrating the parameterization of an example network architecture for a text classifier model according to an example embodiment.

FIG. 3 is a block diagram illustrating a parameterization of a network architecture for the string parser model according to an example embodiment.

FIG. 4 is a flowchart illustrating a method of processing speech to commands according to an example embodiment.

FIG. 5 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Voice-based interaction allows users to issue commands without traditional input devices like a mouse, keyboard, or touch screen. Natural Language Processing (NLP) is crucial for understanding user inputs, accommodating various expressions and nuances. AI models analyze the semantics of text-converted commands, interpreting intent and extracting relevant information.

One typical AI model used for processing text is referred to as a bag of words model that use text vectors that represent text as word collections having frequences and word embedding based models. Another type of model for processing text is a Bidirectional Encoder Representations from Transformers (BERT) which uses bidirectional attention to capture contextual information from both previous and subsequent words. Compact versions of the base BERT model, which consists of 110 million parameters, may be obtained by varying the number of Transformer layers (L), the size of the representation vector (H), and the number of attention headers (A). One example compact model, termed BERT Tiny (L=2, H=128, and A=2), comprises 4.4 million parameters. An increase in the application of pre-processing techniques, such as the elimination of stopwords and punctuation, resulted in a decrease in model training accuracy. This suggests a need for careful consideration of pre-processing techniques, as they could potentially increase the error rate of the model.

An improved voice to command interaction system for embedded devices allows users to control the devices in an intuitive and convenient way. Inferencing processes may be performed locally, ensuring results in the order of milliseconds and avoiding dependence on external resources.

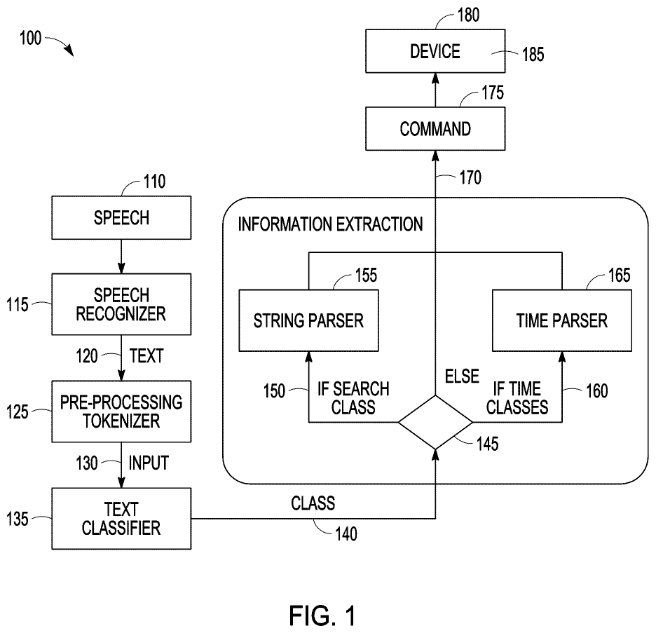

FIG. 1 is a block diagram of an improved voice to command interaction system 100. A high-level description of system 100 is provided followed by further details of each of the elements of system 100.

System 100 receives speech 110 which is recognized at speech recognizer 115 to provide text 120 corresponding to the speech 110. In one example, Speech recognizer 115 may execute locally on the system 100 which may be a local device, or remotely such as by networked cloud-based computing resources.

Recognized text 120 is preprocessed at a pre-processing tokenizer 125. Tokenizer 125 splits the text 120 into smaller units, such as words or portions of words and maps the units to unique token identifiers (IDs). The token IDs are used as input 130 to a text classifier 135.

Text classifier 135 in one example is model having a BERT architecture and is used for intent classification of text commands into classes of commands. The text classifier 135 may be trained for specific commands to be executed by the local device. The specific commands may be a limited set of commands corresponding to commands acceptable and executable by the local device. The text is thus classified into mapped classes 140.

The mapped classes are provided to a decision block 145 which routes commands that include searching via 150 to a string parser 155. String parser 155 may be a token classification model based on BERT for example, to identify relevant segments of text to be used to execute the search command.

Example text input with relevant segments (search terms or search string) of text to be searched for include:
“Look up healthy recipes for dinner.”
“Search for movie reviews on the internet” and
“Find on internet about popular people”

Decision block 145 will route commands that involve time, such as a time for a meeting, via 160 to a time parser 165. In one example time parser 165 may utilize Regex rules and receives a list of words extracted from the input 130. The rules are applied to map the words to different types of tags. A first tag is not related to time, a second tag may include pattern, such as multiple times. AM, PM, relative days such as tomorrow, absolute days identified by date, and even months are additional tags that may be mapped.

Examples of text input and the corresponding output from time parser 165 include:

“Set a timer for 30 seconds and 25 minutes.”:
Output: ([30,25], [“sec”,“min”])
“Set an alarm for tomorrow 4:00 p.m.”:
Output: ([1,4,0,1]), [“relative_day”,“hour”,“min”,“period”])

Decision block 145 will route, via 170, commands that are neither search nor time related commands directly for execution at commands 175 for a device 180, such as an interactive screen. Device 180 may incorporate the components of system 100 which may be embedded in device 180 and not require a network connection to access additional processing resources to convert text to commands 175. In one example, device 180 may also embed speech recognizer 115, or rely on a fast network connection for performing speech recognition.

If the string parser 155 or time parser 165 were invoked, information is extracted to parameterize the command or otherwise provide information for correctly executing the comment 175.

Text classifier 135 is optimized to execute as an embedded model on the local device. An embedded model is a model that runs on a local device without the need for a network connection. Text classifier 135 can be greatly reduced in size by limiting the number of classes of commands that are executable by local device once identified. The use of the string parser 150 and time parser 165 relives the text classifier 135 from having to be trained to extract additional information for search and time related classes of commands.

Further details regarding the components of system 100 are now provided. Speech recognizer 115 is responsible for locally transcribing the speech 110 audio received from a user of system 100. Tokenizer 125 is a pre-processing block in which the text is encoded in a process called tokenization to be used in the models. The text classifier 135 is a trained model with for intent classification of text commands, returning which command is to be executed by the system 100. The string parser 155 is a trained token classification model, which identifies the most relevant part of the input 130 text. It is used in internet search commands, returning the relevant part of this text to feed the search engine. (i.e. “search for the latest sports news” returns “latest sports news”, “look up funny videos on the web” returns “funny videos”). Finally, the time parser 165 is used in commands that contain time information, in order to extract months, days, hours, minutes, and seconds. The time parser 165 need not be a trained model, but uses an analysis solution with a Regex pattern, followed by a business rule. Commands 175 are returned, along with extra information for execution by system 100.

Speech recognizer 115 is responsible for transcribing the audio, and is performed in one example by Android® SpeechRecognizer with a Google® voice engine. Transcribing may also be accomplished with other tools such as Microsoft® Azure® Speech to Text or Whisper System by OpenAI™.

System 100 exhibits minimal dependence on the audio transcription tool utilized, therefore, it allows perfect integration with other speech recognition solutions, such as the OpenAI's Whisper, which includes optimized versions for embedded systems, featuring reduced-size variants tailored for local execution.

Pre-processing by tokenizer 125 (tokenization) splits text into smaller units and maps them to unique tokens (IDs). As a midpoint between words and characters, subword units retain linguistic meaning (like morphemes), while alleviating out-of-vocabulary situations even with a relatively small-size vocabulary. The tokenizer may be selected based on a trade-off between accuracy and complexity. In one example, a Fast WordPiece tokenizer is used and has a complexity of O(n) (where n is the input length), and is based on the WordPiece tokenizer. A vocabulary with 30,522 tokens may be used.

Given a set [symbol] of texts and a vocabulary [symbol] , where [symbol] ⊂ [symbol] , the vocabulary [symbol] contains a list of unique words (or subwords) [symbol] where each one is associated with an index i. Hence, a tokenizer represents a text Tᵢ into a vector of tokens Xᵢ with predefined size d, where xᵢⱼ is a token composed of the index j of an associated token [symbol] ⱼ∈Tᵢ Tokenization is performed through the following steps:
(1) Splitting the text into subwords;
(2) Mapping each subword to its associated token ID. Out-of vocabulary subwords are represented by the [UNK] token;
(3) Adding the special tokens [CLS] at the start and [September] at the end of the sequence.
(4) Fixing the number of tokens through truncation and padding, using the special token [PAD];

The vector of tokens is then converted into a dictionary [symbol] composed of three equal size arrays following keys: “input mask” (im), “input type ids” (itid), and “input word ids” (iwid), to match BERT standard input. iwid contains the vector of tokens; im is composed of a binary array, indicating with 0 the tokens obtained by padding and with 1 the valid tokens; and itid is entirely filled with zeros, since its original use is not suitable for this application.

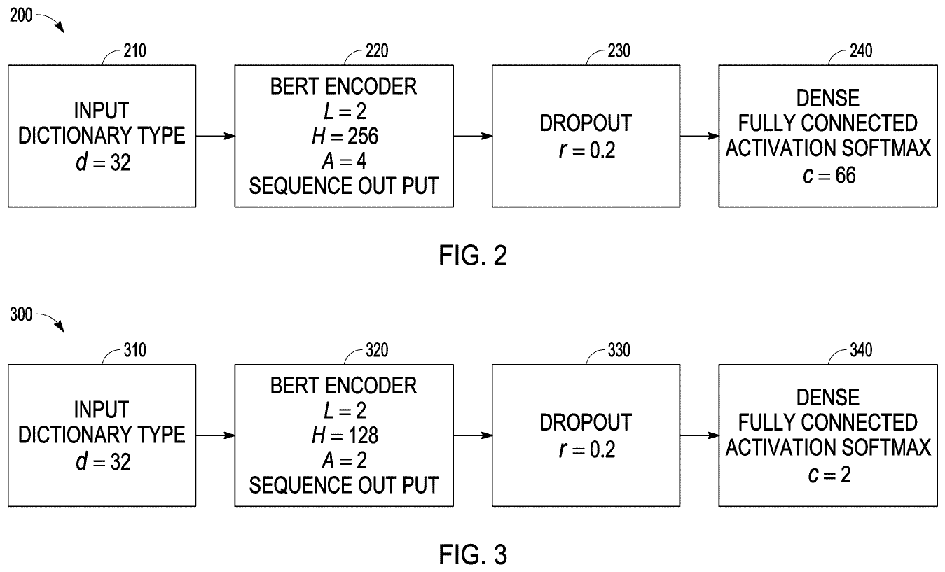

FIG. 2 is a block diagram illustrating the parameterization of an example network architecture 200 for the text classifier 135 model. Text classifier 135 in one example is a model with BERT architecture for intent classification of text commands. The primary objective is to determine which command should be executed by the system. The model's architecture includes the following components:
(1) Input Layer 210: Receives a standard dictionary [symbol] , comprising arrays of predefined size d. These arrays are obtained through the tokenization process.
(2) BERT Encoder 220: Applies the BERT encoder, which consists of L transformer encoder blocks, H hidden units (or embedding size), and A attention heads.
(3) Output Representation: Uses pooled output of BERT, representing an embedding vector for all input tokens. Following this, a dropout layer 230 with a rate r is applied to mitigate overfitting.
(4) Final filly connected layer 240 includes a softmax layer, with the number of neurons c equal to the total number of mapped classes.

In one example, the device 180 is an interactive screen such as a large smart whiteboard having a touchscreen with an input mechanism 185 to initiate receipt of a voice command. Such whiteboards are generally used in conference rooms for meetings. Other devices that accept and execute a set of commands may also utilize system 100. The input mechanism could be an icon or menu selection on the screen or on a remote-control device such as a smartphone, pad, keyboard, or laptop wirelessly coupled to the whiteboard that upon selection, results in an activation signal to enter a receive speech 110 mode by system 100.

Network parameters (d, L, H, A, r) for the text classifier 135 model may be determined through hyperparameter optimization. In one example, a dataset of the text classifier 135 comprises short English texts, each representing a single command associated with a specific class. The inputs are tuple where texts are in the string format and classes are integers, e.g., terminate the system (0); begin external audio recording (47); please, set system to dark mode (33); please, navigate to settings on system (27); enter whiteboard (50); machine, power on wireless (20).

In one example, two data augmentation techniques may be employed to increase the dataset volume and intra-class variability: (i) uses synonyms to refer to the device, including device, monitor, system, machine, and equipment, consequently, any reference to the equipment was first labeled as “{device}”, to be randomly replaced later by one of the five variations mentioned; (ii) randomly inserting the word “please” at the beginning or end of randomly selected sentences within each class. It is noteworthy that a special class named unrec (unrecognized) was developed to denote phrases that cannot be mapped to one of the pre-established commands, either due to ambiguous meaning or non-existent commands.

To mitigate model bias in inferring classes with unequal sample sizes, the data may be balanced such that each class contains an equal number of samples. 180 samples were chosen per class, except for the search and unrec classes, which had 217 and 595 commands, respectively. Consequently, the resulting dataset consisted of 12,332 sentences, mapped into 66 classes.

Given that the distinction between upper and lower case letters does not impact the model's accuracy in this scenario, and the removal of common stop words such as “on”, “off”, “up”, “down”, and others-often used in the classification of longer texts-would lead to the loss of crucial information, it was decided, as part of a data preprocessing strategy, to simply convert all texts to lowercase and retain all words, including stop words.

The training parameters for the text classifier 135 model are: Optimizer: AdamW1, Learning rate: 10-5, Weight decay: 0.01, 1st moment decay rate (beta1): 0.9, 2nd moment decay rate (beta2): 0.999, Constant for stability (epsilon): 10-7, Batch size: 16, Loss function: Sparse categorical cross-entropy, Stop criterion: 5 epochs without reducing loss.

The TextClassifier model training was conducted in two stages, initially, a higher learning rate of 0.003 was utilized, with all model weights frozen except for the output layer, subsequently, all model weights were unfrozen to facilitate full adjustment.

After training, the model may be converted to .tflite format to ensure compatibility for mobile deployment. Additionally, post-training quantization may be applied using float16 to reduce the size of the model and decrease inference processing time. The inclusion of a comprehensive standard vocabulary in the BERT solution enables the text classifier 135 model to handle unseen words during training.

String parser 155 is a token classification model in one example based on BERT and is designed to pinpoint the most pertinent segments of the input 130 text. String parser 155 shares architectural similarities with the Text classifier 135, with differences only in the encoder output and the model's output layer. The BERT output is now a sequence output, represented as a matrix, where each row corresponds to the embedding of each input token. The model's softmax layer, on the other hand, yields an output of shape (2, d), matching the size of the input tokens. This output consists of zeros and ones, indicating whether the corresponding input token is part of the relevant text or not, respectively.

In one example, the following procedure is followed to extract the relevant part of text:
(1) Pre-processing tokenizer 125 to obtain the input 130 dictionary and, consequently, the token list from the “input word ids” key;
(2) Feed the trained string parser 155 model with the input 130 dictionary to obtain the token classification list;

A string parser 155 dataset in one example consists of internet search commands, each associated with a segment of interest from this text to serve as input for the search engine, e.g., input text look up funny videos on the web-output funny videos; input text search for the latest sports news-output latest sports news; input text browse example.xyz-output example.xyz.

For the string parser 155 model training, an auxiliary encoding function converts the output text into a classification vector consisting of zeros and ones. These values signify whether each token belongs or not, respectively, to the segment of interest based on the input text. The input text is converted to lowercase and stop words are retained. The resulting dataset comprises 812 sentences in one example.

FIG. 3 is a block diagram illustrating a parameterization of a network architecture 300 for the string parser 155 model and include an input layer 310, BERT Encoder 320, dropout layer 330, and fully connected layer 340. Training parameters remain consistent with those of the text classifier 135, except for the stop criterion, now set to 8 epochs in one example without loss reduction. Training may be conducted in two phases, following the same protocol as used for the text classifier 135 model training.

Upon completion of training, the model may be converted to the .tflite format, followed by post-training quantization using float16 to reduce model size.

Time parser 165 is designed to extract temporal information (months, days, hours, minutes, and seconds) from commands. The time parser 165 adapts to variations in language, recognizing period expressions (e.g., morning, afternoon, evening, night) equivalent to AM/PM, common hour expressions (noon, midnight, half, quarter), and days of the week (including relative references like tomorrow). Instead of relying on a trained model, the time parser 165 employs a Regex based analysis approach associated with specific business rules.

The Regex module receives a list of words extracted from the input text, followed by mapping each word to one of the seven tags via Regex rules (case-insensitive) in the form of business rules, in which the tags in one example may include:
(0) Other-anything that is not time related;
(1) Time pattern (e.g., “5:00”, “11:30”);
(2) AM Period (e.g., “a.m.”, “morning”);
(3) PM Period (e.g., “p.m.”, “afternoon”);
(4) Relative days (e.g., “monday”, “tomorrow”);
(5) Absolute days (e.g., “12”, “25”);
(6) Months (e.g., “january”, “december”).

The business rules leverage the word and tag lists to extract the intended temporal information or flag an error under specific conditions. The function executes the following steps:
(1) Initial Verification: Checks for inconsistencies and out-of context inputs. Flags as invalid if the tag list lacks sufficient information to characterize a timing command (type 0), has undesired multiple tags (e.g., multiple relative days), or contains a sentence without a time pattern (tag 1).
(2) Information Extraction: Iterates over the tag and word lists to populate an output structure with values representing month, absolute day, relative day, day period, hour, and minute.
(3) Information Validation: Ensures the extracted information matches the expected time pattern. Flags as invalid if month>12, absolute day>31, hour≥12 with day period, hour≥24, or minute≥60.

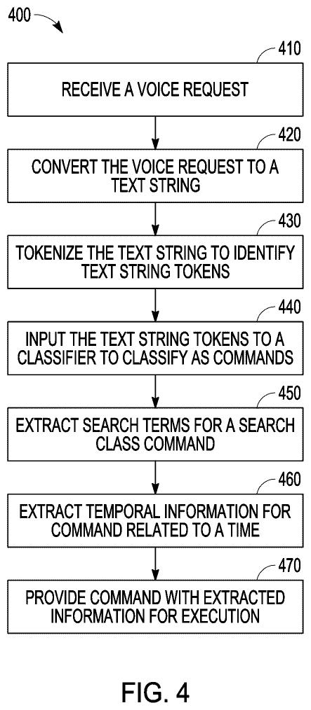

FIG. 4 is a flowchart illustrating a method 400 of processing speech to commands. Method 400 begins at operation 410 by receiving a voice request to execute a command for a device. Operation 420 obtains a text string corresponding to the voice request. The text string is tokenized at operation 430 to generate text string tokens.

The text string tokens are used as input to a text classifier at operation 440. The text classifier has been trained to identify command classes corresponding to the voice request. The command classes in one example include a search class command, a time class command, and other commands. The text classifier classifies an intent of the text string and includes a softmax output layer having a number of neurons equal to the number of command classes. The text classifier may be trained with an equal number of samples for each class and may be post trained using quantization to reduce model size.

Operation 450 extracts information from the text string tokens via a string parser for a search class command. The string parser may be a model trained to find search terms from speech including commands and is post trained using quantization to reduce model size.

Time information is extracted at operation 460 from the text string tokens via a time parser. The time information may be referred to as temporal data related to a command involving time, such as a request for a meeting at a particular time. The time parser may include a Regex module having rules to map words extracted from the text string tokens to temporal information corresponding to the command. The commands along with extracted information are provided to the device at operation 470 for execution.

In one example, method 400 is embedded on the device which may be an interactive screen following receipt of an activation signal from user input via the interactive screen.

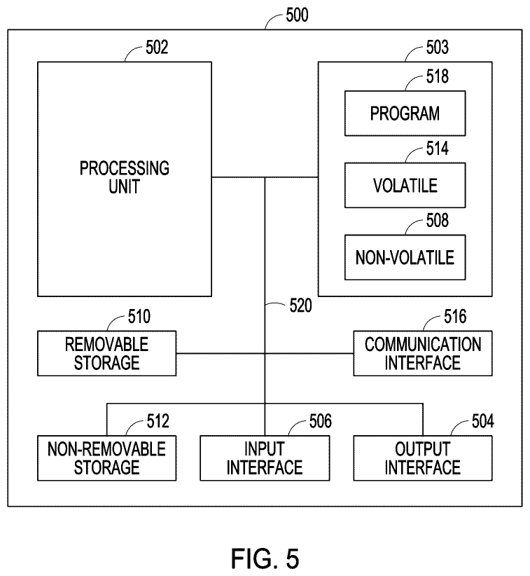

FIG. 5 is a block schematic diagram of a computer system 500 to perform speech to command processing and for performing methods, models, and algorithms according to example embodiments. All components need not be used in various embodiments.

One example computing device in the form of a computer 500 may include a processing unit 502, memory 503, removable storage 510, and non-removable storage 512. Although the example computing device is illustrated and described as computer 500, the computing device may be in different forms in different embodiments. For example, the computing device may instead be a smartphone, a tablet, smartwatch, smart storage device (SSD), or other computing device including the same or similar elements as illustrated and described with regard to FIG. 5. Devices, such as smartphones, tablets, and smartwatches, are generally collectively referred to as mobile devices or user equipment.

Although the various data storage elements are illustrated as part of the computer 500, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 503 may include volatile memory 514 and non-volatile memory 508. Computer 500 may include—or have access to a computing environment that includes—a variety of computer-readable media, such as volatile memory 514 and non-volatile memory 508, removable storage 510 and non-removable storage 512. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 500 may include or have access to a computing environment that includes input interface 506, output interface 504, and a communication interface 516. Output interface 504 may include a display device, such as a touchscreen, that also may serve as an input device. The input interface 506 may include one or more of a touchscreen, touchpad, mouse, keyboard, camera, one or more device-specific buttons, one or more sensors integrated within or coupled via wired or wireless data connections to the computer 500, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 500 are connected with a system bus 520.

Computer-readable instructions stored on a computer-readable medium are executable by the processing unit 502 of the computer 500, such as a program 518. The program 518 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 518 may be used to cause processing unit 502 to perform one or more methods or algorithms described herein.

### Examples

A computer implemented method for deriving commands from voice includes receiving a voice request to execute a command for a device. A text string is obtained corresponding to the voice request. The text string is tokenized to generate text string tokens. The text string tokens are input to a text classifier trained to identify command classes corresponding to the voice request, the command classes including a search class command, a time class command, and other commands. Information is extracted from the text string tokens via a string parser for a search class command. Time information is extracted from the text string tokens via a time parser and resulting commands and extracted information are provided to the device for execution.

2. The method of example 1 wherein the method is embedded on the device.

3. The method of any of examples 1-2 wherein the device includes an interactive screen.

4. The method of example 3 wherein the method is performed following receipt of an activation signal from user input via the interactive screen.

5. The method of any of examples 1˜4 wherein the text classifier includes a softmax output layer having a number of neurons equal to a number of command classes.

6. The method of any of examples 1-5 wherein the text classifier classifies an intent of the text string.

7. The method of example 6 where in the text classifier is trained with an equal number of samples for each class and is post trained using quantization to reduce model size.

8 The method of any of examples 1-7 wherein the string parser includes a model trained to find search terms from speech including commands and is post trained using quantization to reduce model size.

9. The method of any of examples 1-8 wherein the time parser includes a Regex module having rules to map words extracted from the text string tokens to temporal information corresponding to the command.

10. A machine-readable storage device has instructions for execution by a processor of a machine to cause the processor to perform operations to perform any of the methods of examples 1-9.

11. A device includes a processor and a memory device coupled to the processor and having a program stored thereon for execution by the processor to perform operations to perform any of the methods of examples 1-9.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving a voice request to execute a command for a device;
obtaining a text string corresponding to the voice request;
tokenizing the text string to generate text string tokens;
inputting the text string tokens to a text classifier trained to identify command classes corresponding to the voice request, the command classes including a search class command, a time class command, and other commands;
extracting information from the text string tokens via a string parser for a search class command;
extracting time information from the text string tokens via a time parser; and
providing resulting commands and extracted information to the device for execution.

2. The method of claim 1 wherein the method is embedded on the device.

3. The method of claim 1 wherein the device comprises an interactive screen.

4. The method of claim 3 wherein the method is performed following receipt of an activation signal from user input via the interactive screen.

5. The method of claim 1 wherein the text classifier includes a softmax output layer having a number of neurons equal to a number of command classes.

6. The method of claim 1 wherein the text classifier classifies an intent of the text string.

7. The method of claim 6 wherein the text classifier is trained with an equal number of samples for each class and is post trained using quantization to reduce model size.

8. The method of claim 1 wherein the string parser comprises a model trained to find search terms from speech including commands and is post trained using quantization to reduce model size.

9. The method of claim 1 wherein the time parser comprises a Regex module having rules to map words extracted from the text string tokens to temporal information corresponding to the command.

10. A machine-readable storage device having instructions for execution by a processor of a machine to cause the processor to perform operations to perform a method, the operations comprising:
receiving a voice request to execute a command for a device;
obtaining a text string corresponding to the voice request;
tokenizing the text string to generate text string tokens;
inputting the text string tokens to a text classifier trained to identify command classes corresponding to the voice request, the command classes including a search class command, a time class command, and other commands;
extracting information from the text string tokens via a string parser for a search class command;
extracting time information from the text string tokens via a time parser; and
providing resulting commands and extracted information to the device for execution.

11. The device of claim 10 wherein the method is embedded on the device and wherein the device comprises an interactive screen.

12. The device of claim 11 wherein the method is performed following receipt of an activation signal from user input via the interactive screen.

13. The device of claim 9 wherein the text classifier includes a softmax output layer having a number of neurons equal to a number of command classes and classifies an intent of the text string.

14. The device of claim 13 where in the text classifier is trained with an equal number of samples for each class and is post trained using quantization to reduce model size.

15. The device of claim 13 wherein the string parser comprises a model trained to find search terms from speech including commands and is post trained using quantization to reduce model size.

16. The device of claim 13 wherein the time parser comprises a Regex module having rules to map words extracted from the text string tokens to temporal information corresponding to the command.

17. A device comprising:
a processor; and
a memory device coupled to the processor and having a program stored thereon for execution by the processor to perform operations comprising:
receiving a voice request to execute a command for a device;
obtaining a text string corresponding to the voice request;
tokenizing the text string to generate text string tokens;
inputting the text string tokens to a text classifier trained to identify command classes corresponding to the voice request, the command classes including a search class command, a time class command, and other commands;
extracting information from the text string tokens via a string parser for a search class command;
extracting time information from the text string tokens via a time parser; and
providing resulting commands and extracted information to the device for execution.

18. The device of claim 17 wherein the device comprises an interactive screen.

19. The device of claim 17 wherein the text classifier includes a softmax output layer having a number of neurons equal to a number of command classes and classifies an intent of the text string, and wherein the text classifier is trained with an equal number of samples for each class and is post trained using quantization to reduce model size.

20. The device of claim 19 wherein the string parser comprises a model trained to find search terms from speech including commands and is post trained using quantization to reduce model size and wherein the time parser comprises a Regex module having rules to map words extracted from the text string tokens to temporal information corresponding to the command.
